(19) United States
(12) Patent Application Publication
(10) Pub. No.: US 2010/0135768 A1
(43) Pub. Date: Jun. 3, 2010

(54) Column structure with protected turbine

(75) Inventor: John Pitre, Honolulu, HI (US)

Correspondence Address: STEPTOE & JOHNSON LLP, 1330 CONNECTICUT AVENUE, N.W., WASHINGTON, DC, 20036, US

(73) Assignee: Natural Power Concepts, Inc., Honolulu, HI (US)

(21) Appl. No.: 12/461,714

(22) Filed: Aug. 21, 2009

Related U.S. Application Data
(60) Provisional application No. 61/193,395, filed on Nov. 24, 2008.
(60) Provisional application No. 61/189,950, filed on Aug. 22, 2008.

(51) Int. Cl. F03B 15/06; F03B 3/00; F03B 11/02

(52) U.S. Cl. 415/7; 415/151; 415/60; 415/13

(57) ABSTRACT

A turbine system includes a turbine positioned so that its blades are exposed during at least part of their rotation to a region of fluid flow accelerated by a columnar structure, such as a building or a bridge pylon. A protective casing moves to isolate the turbine blades from the fluid flow, thereby protecting the turbine from overpowering conditions. Upwind and downwind fairings may be used when retrofitting pre-existing buildings. Turbines may be positioned on opposing sides of a building. Multiple turbine modules may be positioned in line along peripheries of a building. Turbines may be mounted on in-water structures, such as buoys.

### CROSS-REFERENCE TO RELATED APPLICATIONS

This application claims priority to U.S. Provisional Patent Application, 61/189,950, entitled “Fine Arts Innovation,” and filed Aug. 22, 2008, and U.S. Provisional Patent Application 61/193,395, entitled “ Column Structure with Protected Turbine”, and filed Nov. 24, 2008, the disclosure of both of which is incorporated herein by reference in their entirety.

### STATEMENT REGARDING FEDERALLY SPONSORED RESEARCH OR DEVELOPMENT

None.

### NAMES OF THE PARTIES TO A JOINT RESEARCH AGREEMENT

None.

### BACKGROUND

According to the U.S. Department of Energy, modern, wind-driven electricity generators were born in the late 1970's. See “20% Wind Energy by 2030,” U.S. Department of Energy, July 2008. Until the early 1970s, wind energy filled a small niche market, supplying mechanical power for grinding grain and pumping water, as well as electricity for rural battery charging. With the exception of battery chargers and rare experiments with larger electricity-producing machines, the windmills of 1850 and even 1950 differed very little from the primitive devices from which they were derived. Currently, wind energy provides approximately 1% of total U.S. electricity generation.

As illustrated in FIG. 1, most modern wind turbines typically have 3-bladed rotors 10 with diameters of 10-80 meters mounted atop 60-80 meter towers 12. The average turbine installed in the United States in 2006 can produce approximately 1.6 megawatts of electrical power. Turbine power output is controlled by rotating the blades 10 around their long axis to change the angle of attack (pitch) with respect to the relative wind as the blades spin around the rotor hub 11. The turbine is pointed into the wind by rotating the nacelle 13 around the tower (yaw). Turbines are typically installed in arrays (farms) of 30-150 machines. A pitch controller regulates the power output and rotor speed to prevent overloading the structural components. Generally, a turbine will start producing power in winds of about 5.36 meters/second and reach maximum power output at about 12.52-13.41 meters/second (28-30 miles per hour). The turbine will pitch or feather the blades to stop power production and rotation at about 22.35 meters/second (50 miles per hour).

In the 1980s, an approach of using low-cost parts from other industries produced machinery that usually worked, but was heavy, high-maintenance, and grid-unfriendly. Small-diameter machines were deployed in the California wind corridors, mostly in densely packed arrays that were not aesthetically pleasing in such a rural setting. These densely-packed arrays also often blocked the wind from neighboring turbines, producing a great deal of turbulence for the downwind machines. Little was known about structural loads caused by turbulence, which led to the frequent and early failure of critical parts. Reliability and availability suffered as a result.

It is believed that increases in overall wind-driven electrical energy capacity primarily would use the current wind farm concept concentrated in areas of favorable wind conditions. Alternately, “distributed wind technology” (DWT) applications refer to turbine installations on the customer side of the utility meter. Historically, DWT has been synonymous with small machines. The DWT market in the 1990's focused on battery charging for off-grid homes, remote telecommunications sites, and international village power applications.

Again according to the Department of Energy, DWT historically has been synonymous with small machines and was dominated by three-bladed designs using tail vanes for passive yaw control. Furling, or turning the machine sideways to the wind with a mechanical linkage, was almost universally used for rotor over-speed control. Endurance Windpower, a commercial company, supplies an exemplary, small-wind turbine. According to its website description in 2008, furling works 99.9% of the time but still is not enough to protect the investment in the installation. The Endurance Windpower products include redundant brake calipers to stop the rotor in certain fault and wind conditions. Additionally, the website states that the wind turbine must be placed outside of the turbulence zone of any obstacle.

A variety of other designs have been proposed. Some examples can be found in: V. Chase, “Winners or Losers? Energy Experts Evaluate 13 Wind Machines.” Popular Science, September 1978. Nevertheless, according to the Department of Energy, wind technology must continue to evolve if wind power is to contribute more than a few percentage points of total U.S. electrical demand.

### SUMMARY

An objective of embodiment of the invention is to take advantage of sources of renewable energy that in the past have not been significantly exploited. Further objectives of the invention are:
(i) to integrate electricity generation capacity into buildings and other structures whose primary purpose may not be harvesting wind or water energy;
(ii) to obtain efficiencies in generating electricity by utilizing otherwise inherent properties of buildings whose primary purpose may not be harvesting wind or water energy; and
(iii) to reduce loads on electricity generation grids by providing electricity generation capacity at the point-of-consumption and to contribute electricity to grids.
   These and other objectives are achieved by taking advantage of air or water flow around buildings and other man-made structures whose primary purpose may not be harvesting wind or water energy, such as offices, apartments, bridge supports, water towers, grain silos, river and marine structures, etc. Current wind farms that are built primarily to generate electricity tend to be located on land in areas of naturally high wind. In contrast, most man-made buildings are sited in locations that are less than optimal for wind harvesting, such as in cities or in the lee of geographic formation. While conditions around such man-made buildings might be sub-optimal, they nevertheless may allow for practical and cost effective electrical energy generation. Furthermore, such structures also tend to be at or near points of consumption of electricity, so that generation of electricity at those locations avoids costs of additional transmission capacity from remote locations (such as conventional wind farms, organic-fuel power plants, or nuclear power plants) to points of use and avoids energy loss in transmission. Alternately, man-made structures may be located in environments where harvesting of wind or water energy has been considered unattractive, such as river, tidal, and off-shore marine environments subject to damaging storms and sea conditions. Additional cost efficiencies can be obtained by integrating electricity generation capacity into structures that would be built otherwise for other purposes. Off shore oil platforms that have outlived their productive lives could provide foundations in marine environments. Some of the building costs have or would be incurred anyway, and the marginal material cost is reduced to electricity generation equipment, such as wind capture devices, turbines, generators, and protection shrouds.

An exemplary embodiment is a building having a generally aerodynamic shape designed to accelerate prevailing wind around its periphery. Buildings with large cross sections relative to the prevailing wind provide substantial concentration in energy at the periphery because their large cross-sections act as an aerodynamic dam and redirection device. The amount of air acceleration increases with the building's cross section into the prevailing wind. One or more turbines located around the periphery extract energy from the accelerated air and drive electricity generators.

Over-speed protection presents challenges for such turbines. Turbines sized for relatively low prevailing wind conditions are susceptible to damage during unusually high wind conditions. Storms occasionally expose wind turbines to damaging conditions, especially in relatively unprotected marine environments. In a preferred, “paddle wheel” design, transverse-axis turbines are positioned partially in recesses within the building's aerodynamic footprint. Blades of such turbines cannot easily be “feathered” in high winds conditions for protection, and the underlying structure normally cannot be furled to reduce wind load. A movable shroud is provided. In an “open” position, the shroud allows the turbine to be maximally exposed to the air passing around the structure. In a “closed” position, the shroud forms a protective barrier around the otherwise-exposed portions of the turbines. The shroud can be moved between the closed and open position according to wind conditions.

### BRIEF DESCRIPTION OF THE SEVERAL VIEWS OF THE DRAWING

Reference will be made to the following drawings, which illustrate preferred embodiments of the invention as contemplated by the inventor(s).

FIG. 1 is an illustration of a prior art wind turbine used to generate electricity.

FIG. 2 is a perspective illustration of a column structure with a turbine having a protective shroud in an open position.

FIG. 3 is a perspective illustration of a column structure with a turbine having a protective shroud in a closed position.

FIG. 4 is a top view of a column structure as in FIGS. 2 and 3 with a turbine having a protective shroud in a partially open position.

FIG. 5 is a side view of a column structure as in FIGS. 2 and 3 with a turbine having a protective shroud in an open position.

FIG. 6 is a side view of a column structure as in FIGS. 2 and 3 illustrating a possible generator location.

FIG. 7 is an illustration of an arched building with turbines located with varying axis orientations relative to the ground.

FIG. 8 is a cross-sectional side view of a turbine/shroud module.

FIG. 9a illustrates a top plan view of the aerodynamic outline of a structure with appropriate aerodynamic characteristics but no recess for housing turbines.

FIG. 9b illustrates a top plan view of the structure of FIG. 9a retrofit with turbines and fairings.

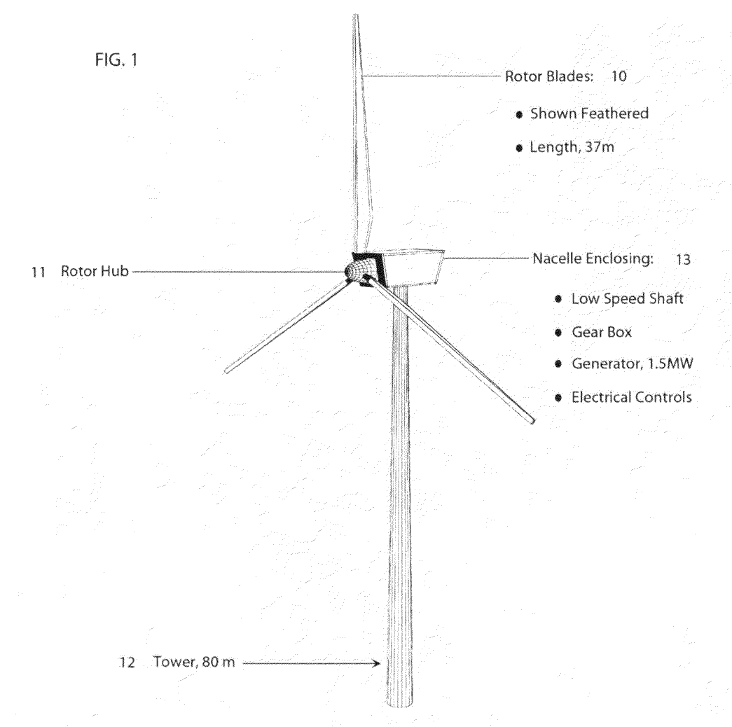

### DETAILED DESCRIPTION OF THE INVENTION

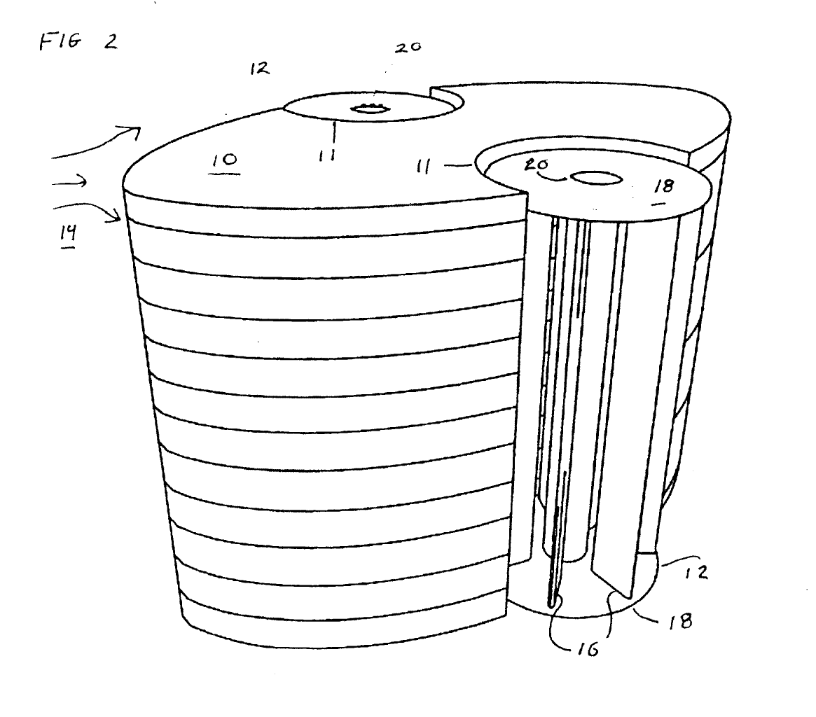

FIG. 2 is a perspective illustration of a column structure 10 with two, transverse-axis turbines 12 having a protective shroud (not shown) in an open position. “Transverse axis” here means that the axis of rotation of the turbine is generally orthogonal (90-degree angle) to the direction of air flow impinging on the turbine. The illustrated column structure 10 has a generally elongated shape and is oriented with its long axis pointed generally parallel to the prevailing fluid flow 14. The fluid may be gas (wind) or liquid (water), but for ease of explanation, reference will be made to wind without intending to limit the invention to air turbines. The column structure has two vertical, partially-cylindrical recesses 11 located on lateral sides of the column structure that house transverse-axis turbines 12. The column structure 10 forms an aerodynamic blockage or dam between the two turbines that redirects and accelerates the prevailing wind 14 around the structure and over the turbines 12. The accelerated air causes the turbines 12 to rotate. The turbine rotation can be used to perform useful work, preferably to generate electricity.

The turbines 12 have the general shape of a paddle wheel with blades 16 running parallel to the rotational axis between two endplates 18. The turbines 12 rotate about central axles 20 and are partially recessed into the column structure 10 so that the blades 16 are exposed to the accelerated air during only a portion of their rotational cycle. During the remaining portion of their rotational cycle, the column structure shields the blades and allows them to return to an upwind position with reduced drag.

The preferred column structures serve one or more functions in addition to their roles as aerodynamic blockage and redirection devices. For example, and without limitation, a column structure may be a bridge support, office building, apartment building, water storage tank, grain silo, warehouse, vertical buoy or other building that has a shape that causes a capture of a larger foot print than the cross-sectional area of turbines alone. Many preexisting buildings have this characteristic, though new building may be designed more effectively to integrate an aerodynamic function with other function(s). Structures may be any shape, including square, round, rectangular, circular, elliptical or even irregular, as long as they cause an acceleration of the prevailing wind around their top, side, or potentially even bottom peripheries.

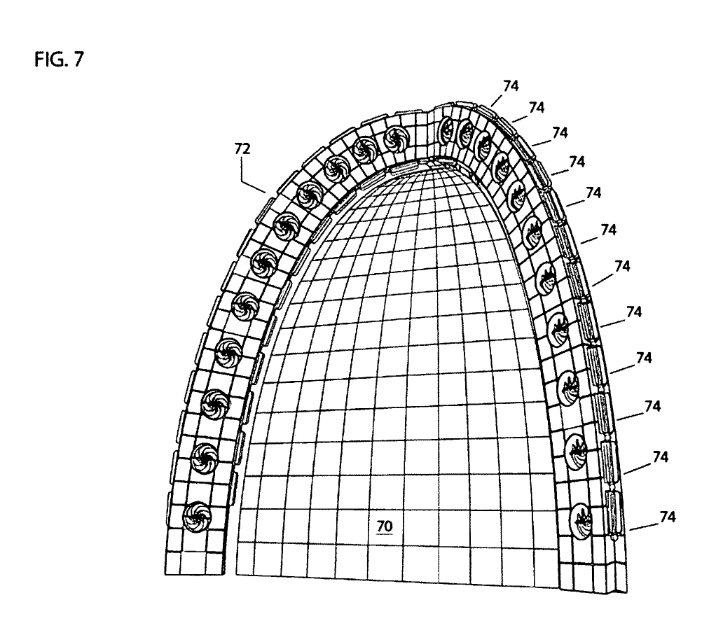

Turbines may extend along full or partial lengths of the top, sides, or even bottoms of a structure depending, at least in part, on the structure's aerodynamic characteristics. For smaller column structures, turbines may have a single rotor. For larger structures, multiple smaller rotors may be stacked or otherwise positioned along a building periphery. FIG. 7, for example, shows a building with an external arch 72. A series of turbines 74 are positioned along the exterior and interior (if there are open spaces) of the arch 72 as discussed further below. Turbines may be placed wherever wind conditions around the structure are favorable.

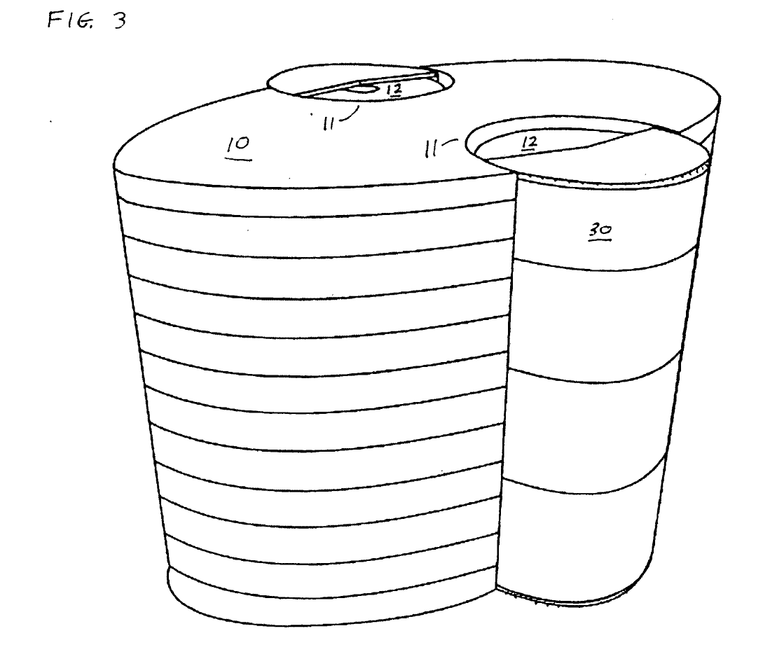

FIG. 3 is a perspective illustration of a column structure 10 with turbines 12 having protective shrouds 30 in a closed position. The shroud 30 is shaped as a portion of a hollow-cylinder, such as 55% of a complete cylinder. In the closed position, the shroud 30 is rotated to the exterior of the recess 11 of the column structure 10 where the shroud 30 at least partially shields the turbine 12 from the airflow. The shroud 30 is mounted to the column structure 10 and rotates between an open and closed position. In the open position, the shroud is rotated to the interior of the recess 11 of the column structure 30, which leaves the turbine exposed to the accelerated air flow. The degree of coverage will depend on the detailed configuration of the turbine 12 and recess 11 and preferably extends around the exposed periphery of the turbine 12 to meet, or to cross at least slightly into, the recess 11. However, the degree of coverage also should minimize the amount the shroud 30 extends out of the recess when it is in an open position to minimize interference with airflow. The degree of coverage may be less than 50%.

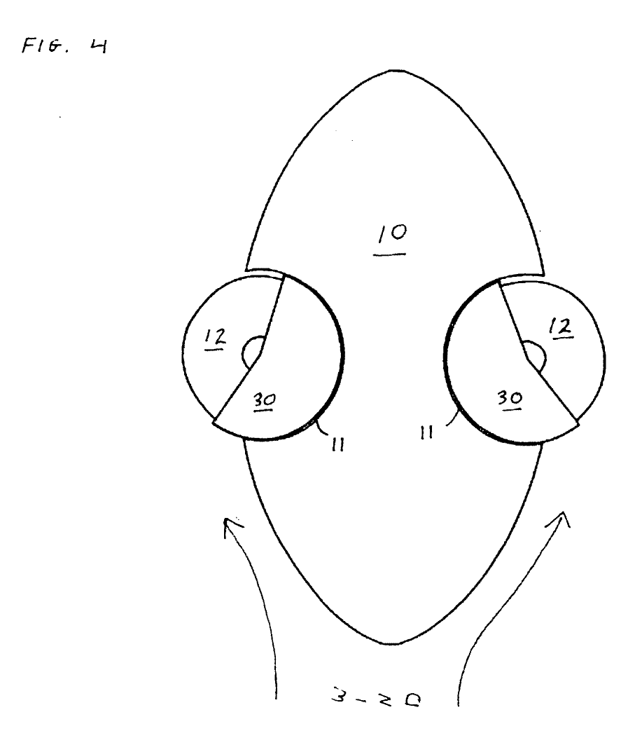

FIG. 4 is a top view of a column structure 30 with turbines 12 having protective shrouds 30 in a partially-closed position. The shrouds 30 can hold any position between fully open (positioned within the column structure recess) to fully closed (positioned to completely cover portions of the turbines that extend outside the column structure recess). A control system positions the shrouds according to wind conditions. In low to moderate winds, the control system rotates the shrouds to the open position to expose the turbines fully to the accelerated air flow. The shrouds 30 close as winds rise to limit exposure of the turbines 12 to excess wind energy and to prevent damage. The primary control mode would maximize energy production up to a limit point. The control would also have secondary control modes to close the shrouds in case of storm or for maintenance.

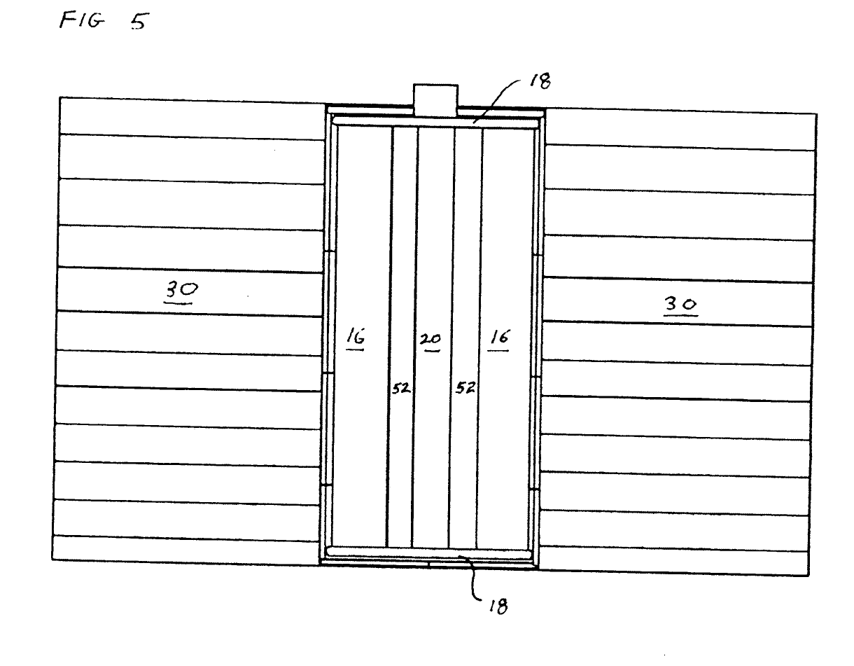

FIG. 5 is a side view of a column structure 30 with protective shrouds (not shown) in an open position. This shroud position exposes turbine blades 16 to accelerated air. Also visible are endplates 18 and axle 20. Turbine blades 16 preferably mount to end-plates 18 while leaving air gaps 52 between the blades 16 and the axle 20.

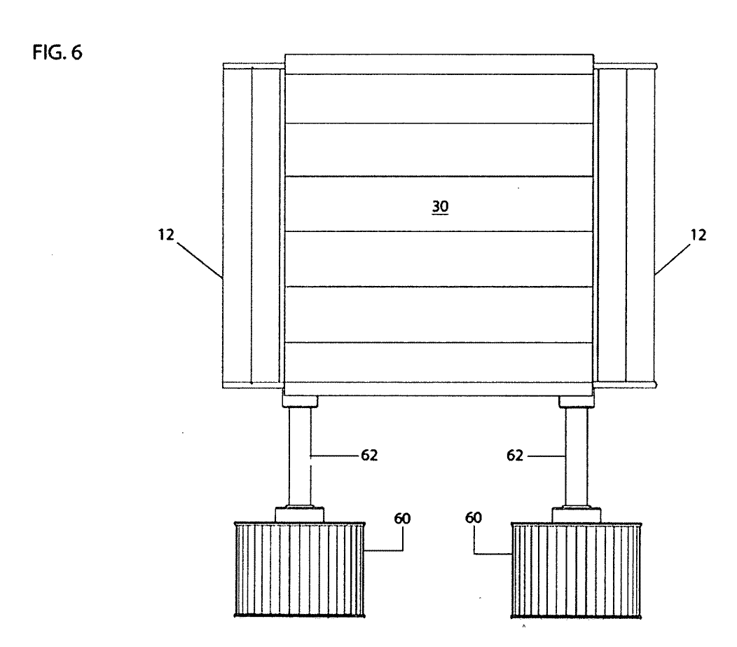

FIG. 6 illustrates a side view of a column structure 30 with turbines 12 and electrical generators 60. Turbines 12 drive generators 60 through shafts 62. The general placement of generators and shafts will be site specific to integrate the generators with the other function(s) of the column structure. For example, in the case of a newly constructed office or residential building, generators may be located in basement or sub-basement levels of the building. For over-water bridge supports, generators might be located above the turbines to avoid costs associated with water protection. As an alternative to direct drive, a transmission system may include a gearing system to increase or decrease revolution speed of the generator relative to revolution speed of the turbines. A transmission system may also include a clutch to disengage turbines from generators.

FIG. 7 is an illustration of an arched building with turbines located with varying axis orientations relative to the ground. The building 70 is a column structure of sufficient size to serve as an aerodynamic dam and to accelerate prevailing wind around its periphery. A curving arch 72 extends around the periphery of the building 70. A series of turbines 74 are located in recesses around the periphery of the arch 72 with protection shrouds (not shown) in an open position to extract energy from accelerated air as it passes around the building 70. Protection shrouds may be controlled individually so that each turbine has a degree of exposure appropriate to its location. Typically, wind speed increases with elevation. Depending on the building's local environment, it is possible that protection shrouds near the top of the building will have a high degree of closure, while protection shrouds near the base would be completely open.

While the building of FIG. 7 shows turbines located along the entire periphery of the arch, turbine configurations would be site specific. Some portions of a building periphery might not experience sufficient wind conditions to make a turbine economical, in which case the turbines might only be located at most favorable locations on the building, such as horizontally along roof tops or on sides of upper floors.

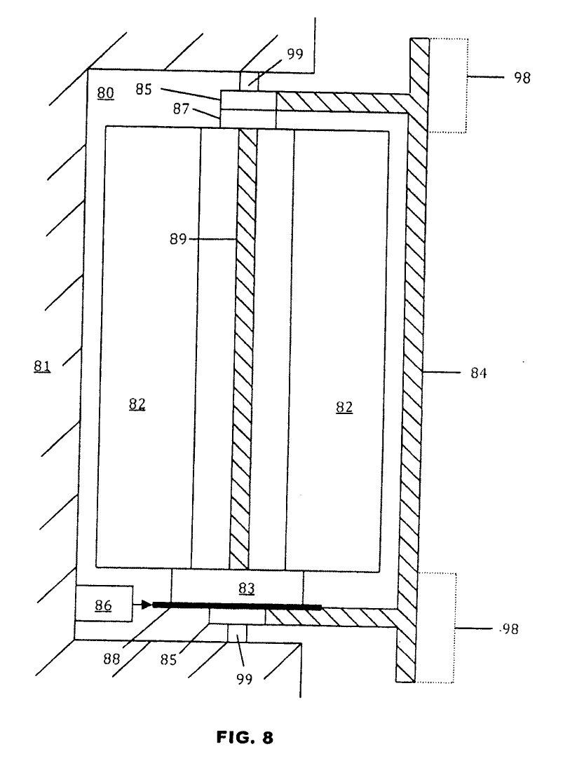

FIG. 8 is a cross-sectional side view of a turbine/shroud module. The components are shown as installed in a recess between floors of a larger structure 81. A transverse-axis turbine is mounted so that its blades 82 are exposed to accelerated air around the outside of the recess 80 during a part of the rotational cycle but shielded from the accelerated air during other parts of the rotational cycle. A generator 83 located within the recess 80 connects directly to the turbine 82 to generate electricity while the turbine rotates. The configuration shown is exemplary. A transmission may be used to optimize the rotational speed of the generator 83 relative to the rotational speed of the turbine. The generator includes a thrust bearing (not shown) to bear the axial load of the turbine 82. A second bearing 87 supports the end of the turbine that is remote from the generator 83. The generator 83 and second bearing 87 both mount to the column structure 81 through fixed posts 99 or other mounting structures.

A protection shroud 84 is shown in a closed position, which positions it to close off the recess 80. The protection shroud 84 connects to, and is supported by two bearings 85. The bearings 85 bear thrust (axial) loads imparted by the weight of the protection shroud 84 while allowing the protection shroud 84 to rotate from the open position to the closed position. The bearings 85 also bear transverse loads caused by wind loading on the protection shroud 84. A shroud motor 86 drives the protection shroud between open and closed positions through gear 88 or other drive system attached to the protection shroud 84. The turbine 82 may optionally include a braking system (not shown).

As an alternative to a motor drive, the leading edge of the protection shroud (relative to the prevailing wind) may include one or more tabs 98, airfoils, or other aerodynamic surfaces positioned so that airflow acting on the tab(s) 98 generates a force that tends to rotate the protection shroud 84 from its open position toward its closed position. Preferably, the protection shroud of one turbine extends axially (in a direction parallel to the turbine's axis of rotation) to meet the shrouds of turbines on the higher and lower floors, and the tabs 98 are located on peripheral portions of the protection shroud 84 so as not to interfere with airflow onto the turbine 82. In such an embodiment, one or more springs (not shown) connects the protection shroud 84 to the larger structure 81 so as to generate a force on the protection shroud 84 that tends to rotate the protection shroud 84 toward the open position. The force of the spring operates in the opposite direction from the wind force on the tab(s) 98. The spring(s) and tab(s) 98 are selected such that, during periods of relatively low wind, the spring(s) bias(es) the protection shroud 84 to the open position. During periods of higher wind, the wind acts on the tabs 98 and closes the protection shroud, at least partially. The degree of closure increases as wind force increases, which causes the protection shroud 84 to reduce exposure of the turbine 82 to the airflow. That in turn automatically regulates the degree of exposure and allows the turbine 82 to continue to operate safely over a wider range wind conditions. A damping system, such as fluid- or air-filed shock absorbers dampen the action of the spring(s) and tab(s) 98 on the protection shroud to reduce oscillation of the protection shroud 84 with wind gusts.

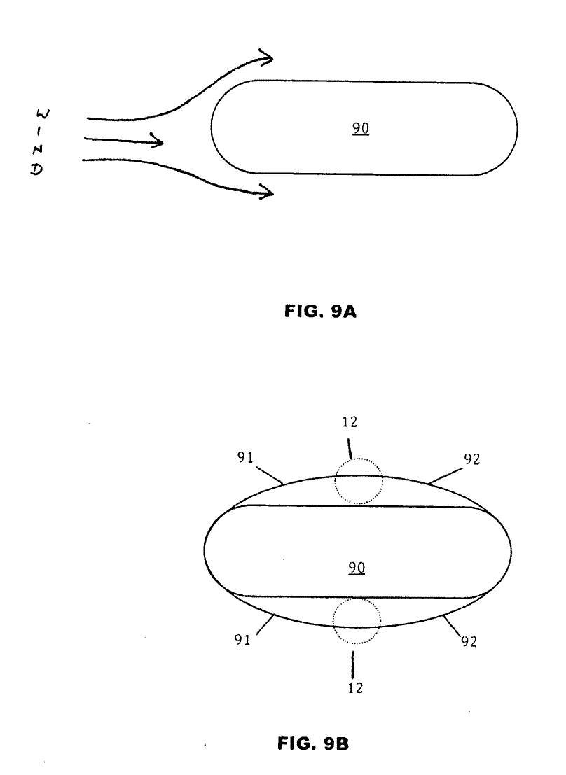

FIGS. 9a and 9b illustrate a preexisting structure retrofit with turbines. FIG. 9a illustrates a top plan view of the outline of a structure 90 with appropriate aerodynamic characteristics but no recess for housing turbines. By way of example, the structure 90 may be a bridge support. FIG. 9b illustrates a top plan view of the structure of FIG. 9a retrofit with turbines 12. Additional fairings 91, 92 are added that, in effect, widen the cross section of the bridge support and allow for the creation of a recess area within the new aerodynamic outline. Forward fairings 91 provide a shielded region in which turbine blades may return to an upwind position with reduced drag (relative to the drag they would experience without the fairings). Downwind fairings 92 smooth downwind airflow and further reduce backpressure on the turbines 12. When wind direction reverses, the roles of upwind fairings and downwind fairings 92 reverse. The geometries of the turbines 12 and fairings 91, 92 may be optimized for the prevailing wind direction, and balanced for operability during reverse wind conditions.

While the description above has focused on wind turbines, they also may be water turbines used in structures built in water environments, such as river, tidal flow, and off-shore current flows. For example, a bridge support may be fit with a wind turbine above the water line and a water turbine below the water line where the bridge support causes an acceleration of the water flow around its periphery. Additionally, wind turbine systems described here can advantageously be mounted on marine and other in-water platforms, such as oil platforms that have outlived their planned service lives, or buoys designed to harvest power from waves or water flow, where at least a portion of the cost of establishing a marine platform can be attributed to a function other than harvesting wind power.

The embodiments described above are intended to be illustrative but not limiting. Various modifications may be made without departing from the scope of the invention. The breadth and scope of the invention should not be limited by the description above, but should be defined only in accordance with the following claims and their equivalents.

What is claim is:

1. A turbine system comprising:
(a) a turbine having rotatable turbine blades, said turbine being positioned so that its turbine blades are exposed during at least part of their rotation to a region of fluid flow accelerated by a columnar structure, and
(b) a protective casing movable to isolate the turbine blades from the region of fluid flow, thereby protecting the turbine from overpowering conditions.

2. The system of claim 1 wherein the columnar structure is fixed in orientation relative to a prevailing wind.

3. The system of claim 1 wherein the columnar structure bears a load in excess of the load of the turbines.

4. The system of claim 1 including a plurality of turbines mounted to the column structure.

5. The system of claim 4 wherein at least two turbines are mounted generally in axial alignment on a common side of the column structure.

6. A turbine system for use with a column structure comprising:
(a) a turbine having rotatable turbine blades, and
(b) a protective casing adapted to be disposed in operative relation to the turbine and to isolate the turbine blades from a fluid flow accelerated by a columnar structure, thereby protecting the turbine from overpowering conditions.

7. The turbine system of claim 6 wherein:
the turbine is rotatable about a first axis, and
the protective casing is rotatable about an axis that is generally in axial alignment with the first axis.

8. The system of claim 7 further including means for rotating the protective casing from an open to a closed position.

9. The system of claim 8 wherein the means for rotating the protective casing includes a drive motor adapted to be disposed in operative relation to the protective casing to rotate the protection shroud about the first axis.

10. The system of claim 8 wherein the means for rotating the protective casing includes an aerodynamic surface coupled to the protective casing and adapted to be acted upon by the fluid flow.

11. The turbine system of claim 8 wherein the means for rotating protective casing includes a spring adapted to be disposed in operative relation to the protective casing to rotate the protective casing.

12. The turbine system of claim 7 furthering including bearings adapted to be disposed in operative relation to the protective casing (i) to allow the shroud to rotate about the first axis and (ii) to bear a thrust load at least equal to the weight of the protective casing.

13. The system of claim 6 further including an upstream fairing configured to block fluid flow from a portion of the turbine when mounted on the column structure upstream of the turbine.

14. The system of claim 6 wherein the upstream fairing is configured to accelerate fluid relative to the column structure when mounted on the column structure upwind of the turbine.

15. The system of claim 6 further including a downstream fairing configured to reduce backpressure on the turbine blades during at least a portion of their rotational cycle when mounted on the column structure downwind from the turbine.

16. A turbine system comprising:
(a) a first transverse-axis turbine having rotatable turbine blades, said turbine being supported by an in-water structure and positioned so that its turbine blades are exposed during a part of their rotation to a region of fluid flow that has been accelerated relative to a prevailing flow, and
(b) a first protective casing movable to isolate the turbine blades of the first turbine from the region of fluid flow, thereby protecting the first turbine from overpowering conditions.

17. The turbine system of claim 16 further including:
(c) a second transverse-axis turbine being supported by the in-water structure and positioned so that its turbine blades are exposed during a part of their rotation to a region of fluid flow that has been accelerated relative to a prevailing flow; and
(d) a second protective casing movable to isolate the turbine blades of the second turbine from the region of fluid flow, thereby protecting the second turbine from overpowering conditions.

18. The turbine system of claim 17 where the in-water structure is a buoy.

19. The system of claim 17 where the in-water structure is designed to harvest energy from water flow.

20. The system of claim 17 where the in-water structure is designed to harvest energy from waves.
